(19) United States
(12) Patent Application Publication
(10) Pub. No.: US 2012/0234997 A1
(43) Pub. Date: Sep. 20, 2012

(54) CROSSARM BRACKET

(75) Inventor: John Philip RENNICH, Chattanooga, TN (US)

(73) Assignee: Sherman & Reilly, Inc., Chattanooga, TN (US)

(21) Appl. No.: 13/422,951

(22) Filed: Mar. 16, 2012

Related U.S. Application Data
(60) Provisional application No. 61/453,834, filed on Mar. 17, 2011.

(51) Int. Cl. H02G 1/00; B23P 11/00

(52) U.S. Cl. 248/219.1; 29/428

(57) ABSTRACT

A crossarm bracket suitable for use with crossarms constructed of various materials, including wood, fiberglass or other similarly-constructed composite crossarms. In some embodiments, the crossarm bracket comprises a top bracket comprising a first attachment point and a second attachment point and at least one flexible compression member having a first attachment end for attaching a first end of the at least one flexible compression member to the first attachment point and a second attachment end for attaching a second end of the at least one flexible compression member to the second attachment point, thereby attaching the at least one flexible compression member to the top bracket. In some embodiments, the crossarm bracket further comprises a flexible compression member tightening mechanism, such as a come along, to secure the top bracket to the crossarm.

### CROSS REFERENCE TO RELATED APPLICATION AND PRIORITY CLAIM

This application claims the benefit, under 35 U.S.C. §119(e), of U.S. Provisional Patent Application No. 61/453,834, filed 17 Mar. 2011, entitled “Crossarm Bracket,” the entire contents and substance of which is incorporated herein by reference in its entirety as if fully set forth below.

### BACKGROUND OF THE INVENTION

1. Field of the Invention

The present invention relates to systems that secure stringing blocks to the crossarm of a utility pole.

2. Description of the Related Art

Stringing blocks are a type of pulley used in the power industry (and other utilities) to support conductors and ropes during installation as the conductors are pulled from one point to the next along a line of power poles. Stringing blocks are commonly used for stringing cable in overhead applications across crossarms that are mounted to the poles. The crossarms allow several conductors to be run parallel to one another without danger of touching. A mounting attachment is used to secure the stringing block to the crossarm.

There are two commonly used attachment designs, typically called “crossarm brackets” that have filled this role. Both of these use some form of clamping to retain the bracket to the crossarm. One design clamps the crossarm between the bracket on top and a bar underneath using a threaded fastener and nut on each end of the bracket to apply compression, effectively “pinching” the crossarm between the upper bracket and lower bar. Disadvantages of this design are the installation time required to install and the difficulty of doing so while wearing lineman's gloves, which are usually leather gloves with a heavy rubber inner liner to guard against electrical shock.

Other common designs use a bracket similar to the aforementioned top bracket, but with arms that hang on each side of the crossarm from pivots on the ends of the bracket. A threaded fastener on the underside of the crossarm is used to pull the arms together to clamp against the lower side edges of the crossarm. Since the spacing of the pivots on the top bracket is fixed, slight variations in crossarm thickness affect the clamping action. In practice, this usually results in most of the clamping force being applied at the lower edges of the sides of the crossarm near the threaded rod. A disadvantage of this design is its poor clamping ability when the bracket is side loaded. Since the clamping action is against the lower side edge of the crossarm, there is little resistance to the bracket rotating relative to the crossarm, as if “prying up” from the surface. As the bracket rises, the side arms, which taper inward, create high wedging stresses that crush the wood fiber of the crossarm and ultimately can damage the bracket.

Crossarm brackets typically have several different points for the mounting of the stringing block, allowing it to be used at a variety of angles to accommodate various mounting scenarios. A further disadvantage occurs when the block is mounted asymmetrically, and is thus side-loaded. High compressive forces are created between the bracket and top of the crossarm in this situation, sometimes resulting in failure of the wood fiber.

Historically, either of these designs has been acceptable for use on wooden crossarms since damage to the outer surface does not significantly impair the structural integrity of the solid wooden core. In practice, the highly irregular loading patterns and concentrated stresses, while undesirable, can still be acceptable.

Recently fiberglass crossarms have been introduced to the industry and are rapidly gaining popularity. These are tubular, thin-wall composite structures with a smooth outer surface, and a low-density core of a different material, commonly, structural foam. This type of structure requires integrity in the thin outer wall, or “skin”, to retain load carrying ability. Any significant damage or distortion in the continuity of the skin, including local crushing, severely reduces the ability of the fiberglass crossarm to sustain rated loads.

While it is possible to use the existing bracket designs in this application, the likelihood of damaging the crossarm structure by localized crushing is quite high; if the brackets are used at lower clamping tension to protect the crossarm, the pulling loads that the setup can resist are much lower than are possible with a wooden crossarm, often below the threshold of acceptability. In particular, the side-clamping bracket design has an impractically low side load limit because the bracket can slip on the smooth crossarm surface.

There is a need for a novel bracket design suitable for fiberglass crossarm applications. It is to this need and others that the present invention is directed.

### BRIEF SUMMARY OF THE INVENTION

The present invention is a crossarm bracket that can be used in a variety of applications. The crossarm bracket of the present invention aims to reduce damage to the crossarm while providing the stability needed to attach a stringing block. The present invention can be used with crossarms of varying material, including fiberglass, which is readily damaged using conventional attachment brackets. In one embodiment, the present invention comprises a top bracket, a connecting assembly, and a securing assembly. The top bracket provides the solid mounting interface with the stringing block. In some embodiments, an applied high-friction coating can be used on the underside of the top bracket to reduce slippage of the top bracket on the crossarm.

In some embodiments, the connecting assembly can take the form of a compression member that provides a compressive force around the crossarm. In some embodiments, a D-ring fitting, or other similar fitting, on the compression member can be provided as it can make the tightening operation easier for a user, and has the benefit of preventing the bracket components to be separated in the field. The securing assembly can comprise a ratchet element providing both a mechanism for applying installation tension to the device (by increasing leverage through mechanical advantage) and for retaining the applied tension. The ratchet itself can take many forms.

One exemplary embodiment of the present invention is a crossarm bracket for securing a stringing block to a crossarm of a power pole. The crossarm bracket comprises a top bracket comprising a first attachment point and a second attachment point, a connecting assembly comprising at least one flexible strap having a first end for attaching the at least one flexible strap to the first attachment point, wherein the connecting assembly is attached to a securing assembly, and the securing assembly having a securing assembly attachment point for attaching securing assembly to the second attachment point. In some embodiments, the securing assembly is selected from the group consisting of a come along, cam-lock, double ring, and combinations thereof.

In some embodiments, the top bracket is made from a material selected from the group consisting of aluminum, steel, plastic, and combinations thereof. In still further embodiments, the top bracket comprises a high-friction surface disposed between the top bracket and the crossarm to decrease slippage of the top bracket on the crossarm. In additional embodiments, the high-friction surface comprises, but is not limited to, a material selected from the group consisting of aluminum oxide, aluminum bronze alloy, nickel chromium alloy, carbide, carborundum, and combinations thereof.

In further embodiments, the compression member can be a flexible strap or other type of flexible member such as, but not limited to, a chain, belt, or wire. The strap can be non-rigid or rigid made from a material selected from, but not exclusive to, the group consisting of a woven natural fibers, polymer, nylon, aramid fiber, Kevlar, metallic material, woven metal wire, and combinations thereof. In some embodiments, a flexible strap is UV protected.

An additional embodiment of the present invention is a method for securing a stringing block to a crossarm of a power pole comprising placing a top bracket comprising a first attachment point and a second attachment point on the crossarm of the power pole, attaching a first end of a connecting assembly comprising at least one flexible compression member to the first attachment point, wherein the connecting assembly is attached to a securing assembly, attaching the securing assembly having a second attachment point to the second attachment point, and removing at least a portion of slack in the at least one flexible compression member to secure the top bracket to the crossarm.

A still further embodiment of the present invention is a crossarm bracket for securing a stringing block to a crossarm of a power pole comprising a top bracket comprising a first attachment point and a second attachment point, a connecting assembly comprising at least one flexible compression member having a first end for attaching the at least one flexible compression member to the first attachment point and a second end for attaching the at least one flexible compression member to the second attachment point, and a securing assembly for reducing the length of the connecting assembly to secure the top bracket to the crossarm.

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE FIGURES

The various embodiments of the invention can be better understood with reference to the following drawings. The components in the drawings are not necessarily to scale, emphasis instead being placed upon clearly illustrating the principles of the various embodiments of the present invention.

FIG. 1 is a skewed side view of a crossarm bracket, according to an exemplary embodiment of the present invention.

FIG. 2 is an elevated top view of a crossarm bracket, according to an exemplary embodiment of the present invention.

FIG. 3 is a side view of a crossarm bracket, according to an exemplary embodiment of the present invention.

FIG. 4 is a bottomside view of a crossarm bracket, according to an exemplary embodiment of the present invention.

Any headings provided herein are for convenience only and do not necessarily affect the scope or meaning of the claimed presently disclosed subject matter.

### DETAILED DESCRIPTION OF PREFERRED EMBODIMENTS

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The present invention is a crossarm bracket suitable for use with crossarms of varying construction, including, but not limited to fiberglass and wood crossarms. The prevent invention provides for the ability to affix a top bracket to a crossarm, preferably without damaging the structural integrity of the crossarm under application of rated loads. Some embodiments of the present invention are ergonomically acceptable and promote safe use by the user who typically must use linemen's gloves. For practicality, the installation and removal times of the bracket should preferably be kept to a minimum and should be rugged and reliable in service.

Some embodiments of the present invention use a ratchet-mounted strap (similar in construction to automobile seat belt webbing) acting as a flexible compression member that wraps around the underside of the crossarm, effectively replacing the side hardware and bottom bar or threaded rod. In some embodiments, the strap can have a hook on its end that attaches to the opposite side of the bracket. Once hooked, a D-ring attached to the end of the strap is grasped and pulled to remove slack in the strap. The ratchet mechanism removes the remaining slack in the strap, and then through mechanical advantage applies and maintains tensioning sufficient to keep the bracket in position. To remove the bracket, a release on the ratchet is activated, and tension in the strap is removed. The hook is removed and the bracket becomes free to move. The present invention is not limited to the use of a strap as the flexible compression member. Other flexible compression members, such as chains, are considered to be within the scope of the present invention.

The bracket itself is of a length and width such that specific loading is applied at a pressure suitable for fiberglass crossarms. Additionally, in order to increase resistance to slippage, the bottom surface of the bracket, which contacts the crossarm, can have a surface finish that generates high friction.

Testing of some embodiments of the present invention on various popular fiberglass crossarms has shown that the clamping system has little to no deleterious effect on the fiberglass. Installation and removal times are reduced when compared to some conventional designs. The bracket is readily manipulated while wearing linemen's gloves as the size of each component is selected to be suitable for this purpose. Therefore, the lineman should not feel the need to remove his gloves and impair his safety. An exemplary embodiment of the design is rugged and practical: a strap is UV protected, permanently retained to the bracket by the D-ring, and the high friction coating on the bottom of the bracket is of high strength and securely adhered to the aluminum base. In a preferred embodiment, the present bracket assembly comprises a top bracket, a connecting assembly, and a securing assembly.

### Bracket

The bracket is preferably an aluminum casting, but can be made from other metals or non-metallic materials, and could be produced using other processes, such as stamping or machining. In some embodiments, the bottom of the bracket has an applied high-friction surface to reduce the possibility of slippage, although this is not required. Examples of the friction material include, but are not limited to, aluminum oxides, aluminum bronze alloys, nickel chromium alloys, carbides, or carborundums, although many other materials with similar mechanical properties can be used. The surface can be applied by a method such as plasma spray or sputtering, or can be mechanically bonded using an adhesive.

### Connecting Assembly

The connecting assembly can be a flexible compression member of a length appropriate for this application, and is ideally constructed of a structural woven webbed material similar to that used in automotive seat restraints, but could also take other forms besides a flat shape, such as round, oval, ribbed, or be woven or otherwise formed in an unconventional manner. The flexible compression member material can be metal interlinked chain segments flexible materials such as woven natural fibers, a polymer such as nylon, an aramid fiber such as Kevlar, metallic material such as woven metal wire, or any other non-rigid material or combination of materials possessing sufficient strength.

The fittings on the flexible compression member can comprise a “D” ring on one end of the flexible compression member; the other end of the flexible compression member is permanently attached (in one exemplary embodiment, sewn) around a feature on one side of the top bracket, such as a pin. Alternately, the non-D-ring end of the flexible compression member can have a hook feature, which is used to attach the free end of the flexible compression member to the bracket upon installation. The D-ring could also be made in other shapes, such as round, square, oval, or others, but is of a size such that it can be easily grasped and manipulated by a lineman wearing gloves. This fitting can be eliminated altogether, or its principal function, which is to prevent the flexible compression member from slipping through the ratchet (permitting the components to become separate), could be duplicated by other means, such as rolling the end of the flexible compression member and sewing the multiple layers to provide a “lump” on the end of the strap.

The hook feature is ideally a rigid component, such as a metal pin, integral with the structure of the ratchet, but can also be a stamped, formed steel part of a shape such that it acts as a hook. Further, it could be made of other metallic or non-metallic materials, and could be produced using other processes besides stamping, such as casting. As with the D-ring, the hook is sized to permit easy handling by a gloved user.

As can be seen, the flexible compression member can also be subdivided into shorter lengths which make up the total, which can be attached to one another and to the ratchet in many combinations which provide the function of being able to surround the crossarm, and installing and uninstalling the assembly without sliding it over the end of the crossarm, essentially “breaking” or opening the strap at a minimum of one point along its length.

### Securing Assembly

The securing assembly can be a ratchet assembly to tighten the connecting assembly about the crossarm. It can include a standard, commonly-available device made from metal stampings as illustrated, but could be made from other materials or in a different physical form; an ideal embodiment would have a higher-than-standard number of detent steps on the mechanism, for example, 18 instead of the more common 12 steps, which allows the ratchet take-up to be operated in smaller steps or with shorter motions on the handle.

The ratchet can be positioned in-line with the strap at any point; in the preferred embodiment, the ratchet has a hooking or retaining feature built into its structure which allows it to be attached or detached directly to- or from the top bracket, with all of the strap material between the other side of the top bracket and the ratchet itself.

As described above, the flexible compression member and ratchet assembly could be made up of a number of shorter members, joined in many configurations. For example, instead of attaching the flexible compression member to the top bracket with a hook, a short section of flexible compression member material could be permanently attached to the bracket, and the “break” or “opening” in the strap could thus be moved to the ratchet assembly, or elsewhere in the chain of components.

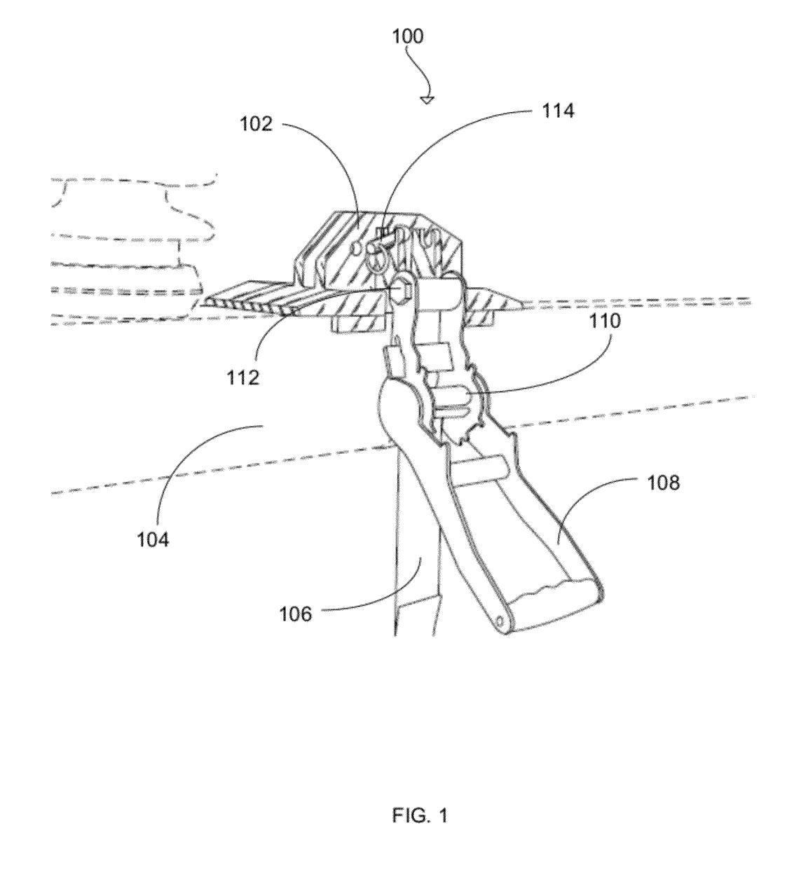

FIG. 1 is an elevated side view of an exemplary crossarm bracket 100. Top bracket 102 is placed on crossarm 104 in order to secure a stringing block (not shown) to crossarm 104. The stringing block is a temporary fixture on crossarm 104 that allows a lineman to string high voltage lines from one crossarm to another. Once top bracket 102 is placed on crossarm 104, top bracket 102 needs to be secured to crossarm 104 to securely hold the stringing block.

Conventional top brackets are secured to crossarms using brackets. While potentially suitable for square wooden crossarms, if the crossarm is not close to being square, the brackets impart a highly compressive force on only a few points of the crossarm in order to fully secure the top bracket to the crossarm. These “pinch points” degrade wood and, in the case of fiberglass, crack the crossarm. The exemplary embodiment of FIG. 1 uses a flexible strap to spread the compressive forces over a greater area on the crossarm when the top bracket is secured to the crossarm, though it should be understood that other types of flexible compression members can be used including, but not limited to, interlocked chain links. By spreading the compressive forces over a greater area, the probability of imparting damaging forces onto the crossarm at any one point is reduced.

Referring again to FIG. 1, strap 106 is installed on one side of top bracket 102 and placed around top bracket 102, ending at a securing assembly. In the embodiment shown in FIG. 1, the securing assembly is come along 108. Come along 108 receives strap 106 into racket mechanism 110. A securing assembly attachment point 112 is attached to an attachment point on top bracket 102. Once come along 108 is attached to top bracket 102, to secure top bracket 102 to crossarm 104, a user engages racket mechanism 110 to pull strap 106 through come along 108, compressing strap 104 onto crossarm 104. Once secured on crossarm 104, a stringing block can be secured to top bracket 102 via pin 114.

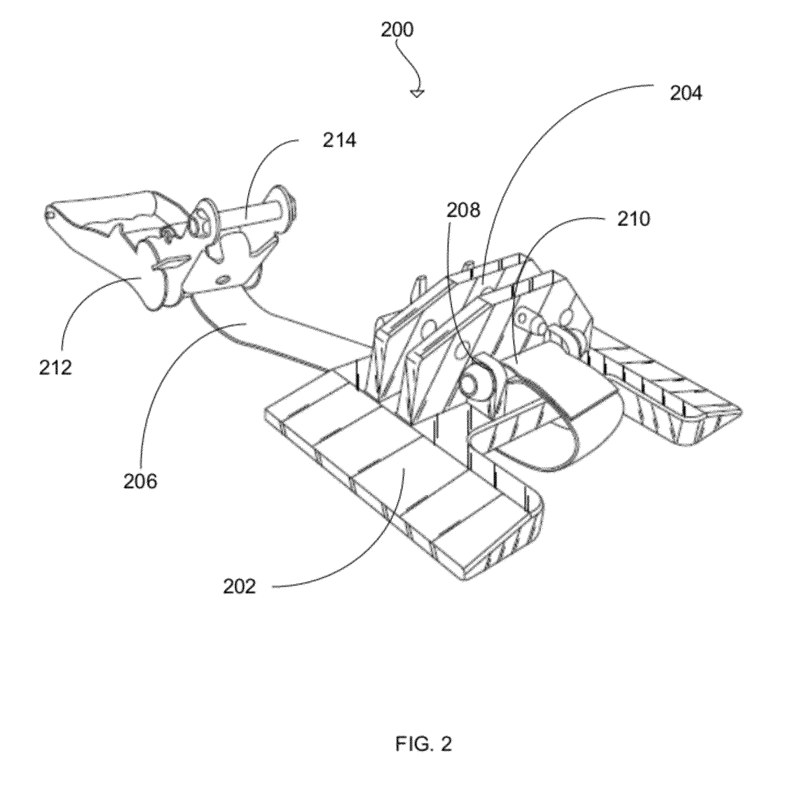

FIG. 2 is an illustration of an embodiment of a crossarm bracket assembly 200 for securing a stringing block to a crossarm. Top bracket 202 is placed on a crossarm of a power pole. A stringing block (not shown) is placed in top bracket 202 receiving space 204. Strap 206 is attached to top bracket attachment point 208 at strap attachment point 210. The exemplary embodiment of FIG. 2 uses a flexible strap to spread the compressive forces over a greater area on the crossarm when the top bracket is secured to the crossarm, though it should be understood that other types of flexible compression members can be used including, but not limited to, interlocked chain links. Strap 206 can be attached to top bracket 202 in various ways, including being sewn around a pin attached to top bracket 202. Strap 206 is wrapped around the crossarm and is attached to come along 212. Come along 212 is attached to top bracket 202 via bracket attachment 214. Once attached, a user uses come along 212 to tighten strap 206 against the crossarm to secure top bracket 202 to the crossarm.

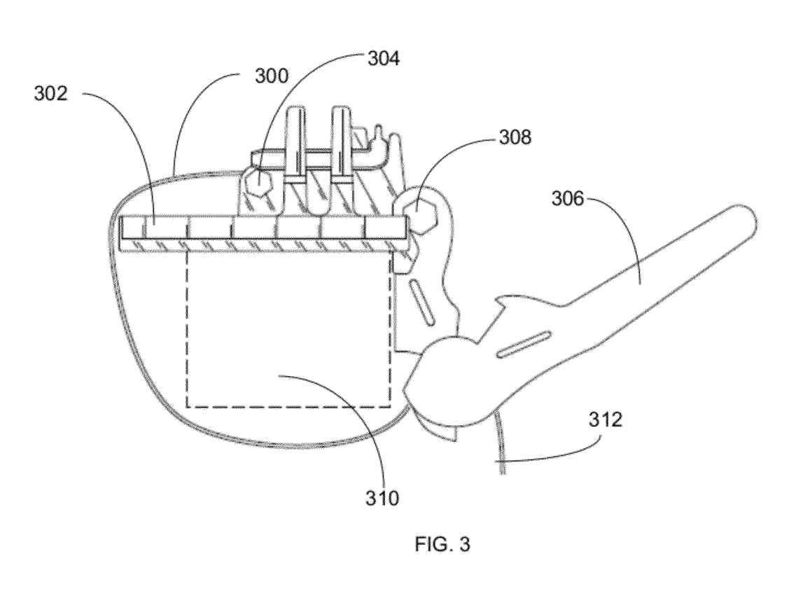

FIG. 3 is a side view of an embodiment of the present invention. Strap 300 is attached to top bracket 302 at first attachment point 304 and attached to a racket-type mechanism, such as come along 306. The exemplary embodiment of FIG. 3 uses a flexible strap to spread the compressive forces over a greater area on the crossarm when the top bracket is secured to the crossarm, though it should be understood that other types of flexible compression members can be used including, but not limited to, interlocked chain links. Come along 306 is attached to top bracket 302 at second attachment point 308. Strap 300 is wrapped around crossarm 310. To remove an initial amount of slack in strap 300, strap 300 can have a portion 312 extending from come along 306. Portion 312 can end in a D-ring or some other configuration that allows a user to gain a grip on portion 312 and pull to reduce a portion of the slack in strap 300. Thereafter, to fully tighten strap 300 against crossarm 310, the user can use come along 306. Portion 312 can also be a breakable stress link. If strap 300 is tightened to a certain tension, to avoid damage to crossarm 310, a stress link can break, relieving stress and minimizing the potential for damage to crossarm 310. The present invention is not limited, though, to portion 312 as the only type of stress link or a way to relieve stress if the tension reaches a certain level. Other types of stress links, or stress relief devices, can be used and are considered to be within the scope of the present invention. Further, in some embodiments, strap 300 may be attached to top bracket 302 at attachment point 304 and attachment point 308, whereby the user will use a length reducing mechanism to reduce the length of strap 300 to increase tension.

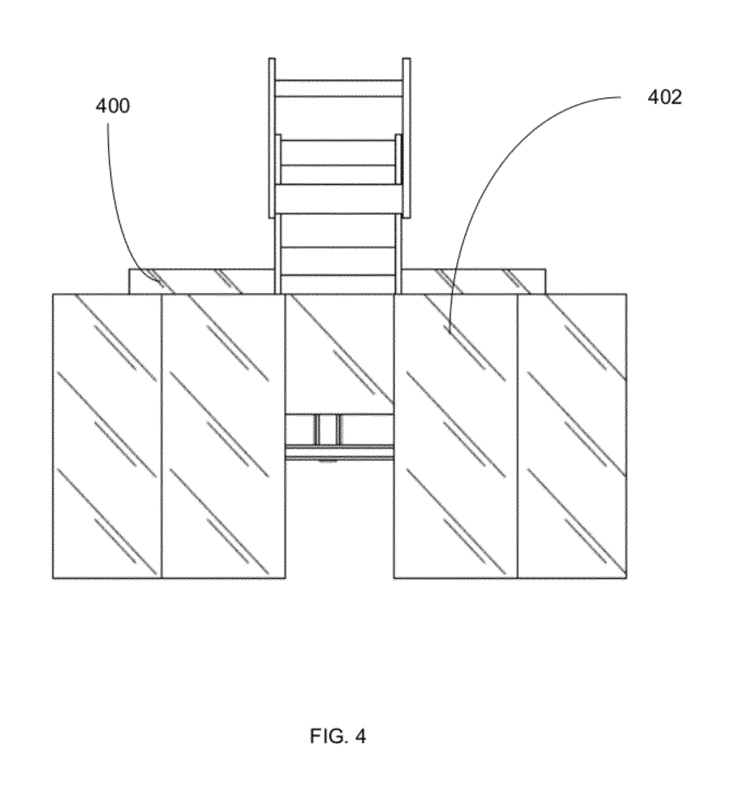

To better secure a top bracket to a crossarm, the top bracket can have disposed thereon a surface to increases the amount of friction between the top bracket and the crossarm. FIG. 4 is a bottomside view of top bracket 400. Top bracket 400 has disposed thereon high-friction surface 402 to decrease slippage of the top bracket on the crossarm. High-friction surface 402 can comprise various surfaces, including, but not limited to, aluminum oxide, aluminum bronze alloy, nickel chromium alloy, carbide, carborundum, and combinations thereof. High-friction surface 402 can be applied using various methods including, but not limited to plasma spray, sputtering or adhesive.

The present invention could potentially be used to mount similar hardware to other structures and orientations beyond the crossarm. One example would be to use the invention in a horizontal orientation around the body of a utility pole.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as can be suggested by the teachings herein are particularly reserved as they fall within the breadth and scope of the claims here appended.

What is claimed is:

1. A crossarm bracket for securing a stringing block to a crossarm of a power pole, the crossarm bracket comprising:
a top bracket comprising a first attachment point and a second attachment point;
a connecting assembly comprising at least one flexible compression member having a first end for attaching the at least one flexible compression member to the first attachment point, wherein the connecting assembly is attached to a securing assembly; and
the securing assembly having a securing assembly attachment point for attaching securing assembly to the second attachment point.

2. The crossarm bracket of claim 1, wherein securing assembly is selected from the group consisting of a come along, cam-lock, double ring, and combinations thereof.

3. The crossarm bracket of claim 1, further comprising a breakable stress link.

4. The crossarm bracket of claim 1, wherein the top bracket is made from a material selected from the group consisting of aluminum, steel, plastic, and combinations thereof.

5. The crossarm bracket of claim 1, wherein the top bracket comprises a high-friction surface disposed between the top bracket and the crossarm to decrease slippage of the top bracket on the crossarm.

6. The crossarm bracket of claim 5, wherein the high-friction surface comprises a material selected from the group consisting of aluminum oxide, aluminum bronze alloy, nickel chromium alloy, carbide, carborundum, and combinations thereof.

7. The crossarm bracket of claim 6, wherein the material is applied using plasma spray, sputtering or adhesive.

8. The crossarm bracket of claim 1, wherein the flexible compression member is selected from the group consisting of interlocked chain links and a strap.

9. The crossarm bracket of claim 8, wherein the strap is UV protected.

10. The crossarm bracket of claim 8, wherein the strap is made from a material selected from the group consisting of a woven natural fiber, a polymer, nylon, aramid fiber, Kevlar, metallic material, woven metal wire, and combinations thereof.

11. The crossarm bracket of claim 8, wherein the first end of the strap is sewn around the first attachment point of the top bracket.

12. The crossarm bracket of claim 1, wherein the first attachment point of the top bracket comprises a hooking mechanism, and wherein the first end of the at least one flexible compression member comprises a pin disengageable from the first attachment point.

13. The crossarm bracket of claim 1, wherein at least one flexible compression member further comprises a second end having a D-ring.

14. The crossarm bracket of claim 1, wherein the at least one flexible compression member comprises a plurality of secondary flexible compression members connected in series to form the at least one flexible compression member.

15. The crossarm bracket of claim 14, wherein the plurality of secondary flexible compression members are removably connected to each other.

16. A method for securing a stringing block to a crossarm of a power pole, the method comprising:
placing a top bracket comprising a first attachment point and a second attachment point on the crossarm of the power pole;
attaching a first end of a connecting assembly comprising at least one flexible compression member to the first attachment point, wherein the connecting assembly is attached to a securing assembly;
attaching the securing assembly having a second attachment point to the second attachment point; and
removing at least a portion of slack in the at least one flexible compression member to secure the top bracket to the crossarm.

17. The method of claim 16, wherein removing at least a portion of the slack in the at least one flexible compression member comprises engaging the securing assembly.

18. The method of claim 16, wherein the securing assembly is selected from the group consisting of a come along, cam-lock, double ring, and combinations thereof.

19. The method of claim 16, wherein the top bracket is made from a material selected from the group consisting of aluminum, steel, plastic, and combinations thereof.

20. The method of claim 16, wherein the top bracket comprises a high-friction surface disposed between the top bracket and the crossarm to decrease slippage of the top bracket on the crossarm.

21. The method of claim 20, wherein the high-friction surface is a material selected from the group consisting of aluminum oxides, aluminum bronze alloys, nickel chromium alloys, carbides, and carborundums.

22. The method of claim 16, wherein the flexible compression member is selected from the group consisting of interlocked chain links and a strap.

23. The method of claim 22, wherein the strap is UV protected.

24. The method of claim 22, wherein the strap is made from a material selected from the group consisting of woven natural fiber, a polymer, nylon, aramid fiber, Kevlar, metallic material, woven metal wire, and combinations thereof.

25. The method of claim 16, wherein the at least one flexible compression member comprises a plurality of secondary flexible compression members connected in series to form the at least one flexible compression member.

26. The method of claim 25, wherein the plurality of secondary flexible compression members are removably connected to each other.

27. A crossarm bracket for securing a stringing block to a crossarm of a power pole, the crossarm bracket comprising:
a top bracket comprising a first attachment point and a second attachment point;
a connecting assembly comprising at least one flexible strap having a first end for attaching the at least one flexible strap to the first attachment point and a second end for attaching the at least one flexible strap to the second attachment point; and
a securing assembly for reducing the length of the connecting assembly to secure the top bracket to the crossarm.

28. The crossarm bracket of claim 27, wherein securing assembly is selected from the group consisting of a come along, cam-lock, double ring, and combinations thereof.

29. The crossarm bracket of claim 27, further comprising a breakable stress link.

30. The crossarm bracket of claim 27, wherein the top bracket comprises a high-friction surface disposed between the top bracket and the crossarm to decrease slippage of the top bracket on the crossarm.

31. The crossarm bracket of claim 30, wherein the high-friction surface is a material selected from the group consisting of aluminum oxide, aluminum bronze alloy, nickel chromium alloy, carbide, carborundum, and combinations thereof.

32. The crossarm bracket of claim 27, wherein the top bracket is made from a material selected from the group consisting of aluminum, steel, plastic, and combinations thereof.

33. The crossarm bracket of claim 27, wherein the at least one flexible strap is made from a material selected from the group consisting of a woven nature fiber, polymer, nylon, aramid fiber, Kevlar, metallic material, woven metal wire, and combinations thereof.
